(19) United States
(12) Patent Application Publication
(10) Pub. No.: US 2006/0209305 A1
(43) Pub. Date: Sep. 21, 2006

(54) Biosensor

(75) Inventors: Koji Kuruma, Kanagawa (JP); Toshiaki Kubo, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/362,821

(22) Filed: Feb. 28, 2006

(30) Foreign Application Priority Data
Feb. 28, 2005 (JP) 052418/2005

(51) Int. Cl. G01N 21/55

(52) U.S. Cl. 356/445

(57) ABSTRACT

An object of the invention is to reduce the negative drift of the baseline signal when measuring a specific binding reaction between a physiologically active substance and a test substance by using a surface plasmon resonance measurement device. The present invention provides a biosensor comprising a substrate on the surface of which a physiologically active substance is immobilized via noncovalent bond, which is used for a method for detecting or measuring a substance that interacts with the physiologically active substance, with the use of a fluid channel system comprising a cell formed on the substrate, in a state where the flow of the liquid has been stopped after the liquid contained in said flow channel system has been exchanged.

### TECHNICAL FIELD

The present invention relates to a biosensor and a method for measuring a change in surface plasmon resonance using the same.

### BACKGROUND ART

Recently, a large number of measurements using intermolecular interactions such as immune responses are being carried out in clinical tests, etc. However, since conventional methods require complicated operations or labeling substances, several techniques are used that are capable of detecting the change in the binding amount of a test substance with high sensitivity without using such labeling substances. Examples of such a technique may include a surface plasmon resonance (SPR) measurement technique, a quartz crystal microbalance (QCM) measurement technique, and a measurement technique of using functional surfaces ranging from gold colloid particles to ultra-fine particles. The SPR measurement technique is a method of measuring changes in the refractive index near an organic functional film attached to the metal film of a chip by measuring a peak shift in the wavelength of reflected light, or changes in amounts of reflected light in a certain wavelength, so as to detect adsorption and desorption occurring near the surface. The QCM measurement technique is a technique of detecting adsorbed or desorbed mass at the ng level, using a change in frequency of a crystal due to adsorption or desorption of a substance on gold electrodes of a quartz crystal (device). In addition, the ultra-fine particle surface (nm level) of gold is functionalized, and physiologically active substances are immobilized thereon. Thus, a reaction to recognize specificity among physiologically active substances is carried out, thereby detecting a substance associated with a living organism from sedimentation of gold fine particles or sequences.

In all of the above-described techniques, the surface where a physiologically active substance is immobilized is important. Surface plasmon resonance (SPR), which is most commonly used in this technical field, will be described below as an example.

A commonly used measurement chip comprises a transparent substrate (e.g., glass), an evaporated metal film, and a thin film having thereon a functional group capable of immobilizing a physiologically active substance. The measurement chip immobilizes the physiologically active substance on the metal surface via the functional group. A specific binding reaction between the physiological active substance and a test substance is measured, so as to analyze an interaction between biomolecules. Examples of the surface plasmon resonance measurement device for carrying out the analysis as mentioned above include that of Japanese Patent Laid-Open No. 2001-330560.

As a method capable of immobilizing various proteins and solidly immobilizing them on a support, Japanese Patent Laid-Open No. 2004-170195 discloses a method for immobilizing a protein, which comprises a first step for activating a reactive group in an immobilization support, the reactive group being capable of covalently binding to a protein to be immobilized having a tag portion, and a second step, following the first step, for allowing a solution containing the protein to be immobilized to act on the immobilization support. In the second step, the protein is immobilized on the immobilization support via the interaction between the tag portion and the tag-bound portion of the immobilization support, and via covalent bond between the reactive group and the protein. In the SPR measurement in Japanese Patent Laid-Open No. 2004-170195, using Biacore 3000 (produced by Biacore), the fluid in a fluid channel system, which is a reference fluid that does not contain a test substance to be measured, is replaced with a sample fluid that contains the test substance to be measured, whereby the binding reaction is initiated between a physiologically active substance and the test substance, followed by the measurement of signal variations over time. However, such measuring method has been problematic in that the baseline signal has a large negative drift, which prevents a highly reliable measurement.

### DISCLOSURE OF THE INVENTION

It is an object of the invention to solve the aforementioned problem of the conventional technologies. Namely, an object of the invention is to reduce the negative drift of the baseline signal when measuring a specific binding reaction between a physiologically active substance and a test substance by using a surface plasmon resonance measurement device.

As a result of intensive studies directed towards achieving the aforementioned object, the present inventors have found that, when a change in surface plasmon resonance is measured by exchanging the liquid contained in a flow channel system using a surface plasmon resonance measurement device equipped with a biosensor comprised of a substrate on the surface of which a physiologically active substance is immobilized via noncovalent bond, the aforementioned object can be achieved by exchanging the liquid contained in the above flow channel system, and then measuring the change in surface plasmon resonance in a state where the flow of the liquid has been stopped. The present invention is based on this finding.

That is to say, the present invention provides a biosensor comprising a substrate on the surface of which a physiologically active substance is immobilized via noncovalent bond, which is used for a method for detecting or measuring a substance that interacts with the physiologically active substance, with the use of a fluid channel system comprising a cell formed on the substrate, in a state where the flow of the liquid has been stopped after the liquid contained in said flow channel system has been exchanged.

Preferably, the substrate is a metal surface or a metal film.

Preferably, the metal surface or the metal film consists of a free electron metal selected from the group consisting of gold, silver, copper, platinum, and aluminum.

Preferably, the biosensor of the present invention is used in non-electrochemical detection, and is more preferably used in surface plasmon resonance analysis.

Preferably, the binding constant (K_{A}) of the noncovalent bond is 10⁷ M or more.

Preferably, the noncovalent bond is any one of avidin-biotin binding, antigen-antibody reaction, coordinate bond by metal ligand, and nucleotide-nucleotide interaction.

Another aspect of the present invention provides a method for measuring a change in surface plasmon resonance which comprises: using a surface plasmon resonance measurement device comprising a metal film on the surface of which a physiologically active substance is immobilized via noncovalent bond, a flow channel system having a cell formed on the metal film, and a light-detecting means for detecting the state of surface plasmon resonance by measuring the intensity of a light beam totally reflected on the meal film; and exchanging the liquid contained in said flow channel system, wherein the above method is characterized in that a change in surface plasmon resonance is measured in a state where the flow of the liquid has been stopped, after the liquid contained in said flow channel system has been exchanged.

### BRIEF DESCRIPTION OF THE DRAWINGS

FIG. 1 shows a surface plasmon resonance measurement device used in the Example.

FIG. 2 shows a dielectric block used in the Example.

In figures, 10 indicates measurement unit, 11 indicates dielectric block, 12 indicates metal film, 13 indicates sample-retaining frame, 14 indicates sensing substance, 31 indicates laser light source, 32 indicates condenser lens, 40 indicates light detector, S40 indicates output signal, 400 indicates guide rod, 401 indicates slide block, 402 indicates precision screw, 403 indicates pulse motor, 404 indicates motor controller, 410 indicates unit connector, and 411 indicates connecting member.

### BEST MODE FOR CARRYING OUT THE INVENTION

The embodiments of the present invention will be described below.

The biosensor of the present invention comprises a substrate on the surface of which a physiologically active substance is immobilized via noncovalent bond, and is used for a method for detecting or measuring a substance that interacts with the physiologically active substance, with the use of a fluid channel system comprising a cell formed on the substrate, in a state where the flow of the liquid has been stopped after the liquid contained in said flow channel system has been exchanged.

In the biosensor of the present invention, a physiologically active substance is immobilized on the surface of the substrate (preferably, the uppermost surface of the substrate) via noncovalent bond as an analyzed molecule.

In a covalent bond, atoms of nonmetal elements share their unpaired electrons and form covalent electron pairs, thereby producing a molecule. The term “noncovalent bond” in this specification refers to any bond as long as it is based on an interaction other than the above-mentioned covalent bond. Preferably, it is either electrostatic interaction (ion bond), hydrogen bond, coordinate bond, or van der Waals force. Also, preferably it contains a packing effect based on a combination of the above interactions and a conformation change of the molecule.

Preferably, the binding constant (K_{A}) of noncovalent bond is 10⁷ M or more. More preferably, it is 10⁷ M or more and 10¹¹ M or less. Even more preferably, it is 10⁷ M or more and 10¹⁰ M or less.

Preferable examples of noncovalent bond in the present invention include avidin-biotin binding, antigen-antibody bond, coordinate bond by metal ligand, and nucleotide-nucleotide interaction.

Other examples of noncovalent bond include an interaction between histidine and nitrilotriacetic acid (NTA), an interaction between glutathione S-transferase and glutathione, and an interaction between maltose-binding protein and maltose.

For example, when the physiologically active substance is a protein, the protein can be immobilized on the substrate via avidin-biotin binding by immobilizing avidin on the surface of the substrate in advance and bringing it into contact with a biotin-labeled protein. Similarly, when other interactions are employed, antigen-labeled protein, histidine-labeled protein, glutathione S-transferase-labeled protein, or maltose-binding-protein-labeled protein, e.g., is prepared, and it is brought into contact with the substrate on the surface of which a corresponding binding molecule, such as an antibody, nitrilotriacetic acid (NTA), glutathione, maltose, and the like, is immobilized in advance. Thus, the protein can be immobilized on the substrate surface via each interaction.

For example, the above-mentioned labeled proteins can be prepared by transforming a host using an expression vector having, in-frame, a gene that codes for a labeled molecule and a gene that codes for a protein, cultivating the resultant transformant so as to cause a labeled protein to be expressed as a fusion protein, and then recovering the fused protein.

When the physiologically active substance is a nucleic acid, various labeled nucleic acids can be prepared in the same way as for proteins and then immobilized on the substrate surface by noncovalent bond. In the case of nucleic acids, a nucleic acid may be immobilized on the substrate via interaction between nucleotides by labeling the physiologically active substance (analyzed molecule) with a tag such as poly A, and bringing the physiologically active substance into contact with the substrate to which oligo dT is bound, for example.

When a substance that interacts with a physiologically active substance is detected or measured by using the biosensor of the invention, the physiologically active substance is detected or measured in a state where the flow of the liquid has been stopped after the liquid contained in the flow channel system comprising a cell formed on the substrate has been exchanged. In the present invention, by using this method, the negative drift of the baseline signal can be reduced, making it possible for the first time to obtain highly reliable binding detection data. The negative drift of the baseline signal occurs due to gradual dissociation of the physiologically active substance when the physiologically active substance is immobilized on the sensor surface via a binding method with a small binding constant, such as noncovalent bond, and the fluid is continuously delivered to the sensor surface.

The time of the stop of the flow of the liquid is not particularly limited. For example, it may be between 1 second and 30 minutes, preferably between 10 seconds and 20 minutes, and more preferably between 1 minute and 20 minutes.

In the present invention, preferably, the liquid contained in a flow channel system is exchanged from a reference liquid containing no test substance to be measured to a sample liquid containing a test substance to be measured, and thereafter, a change in surface plasmon resonance can be measured in a state where the flow of the sample liquid has been stopped.

In the present invention, preferably, a reference cell, to which a substance interacting with a test substance does not bind, is connected in series with a detection cell, to which a substance interacting with a test substance binds, the connected cells are placed in a flow channel system, and a liquid is then fed through the reference cell and the detection cell, so that a change in surface plasmon resonance can be measured.

In addition, in the present invention, the ratio (Ve/Vs) of the amount of a liquid exchanged (Ve ml) in a single measurement to the volume (Vs ml) of a cell used in measurement (and when the aforementioned reference cell and detection cell are used, the total volume of these cells) is preferably between 1 and 100. Ve/Vs is more preferably between 1 and 50, and particularly preferably between 1 and 20. The volume (Vs ml) of a cell used in measurement is not particularly limited. It is preferably between 1×10⁻⁶ and 1.0 ml, and particularly preferably between 1×10⁻⁵ and 1×10⁻¹ ml. The period of time necessary for exchanging the liquid is preferably between 0.01 second and 100 seconds, more preferably between 0.1 second and 10 seconds.

The surface plasmon resonance phenomenon occurs due to the fact that the intensity of monochromatic light reflected from the border between an optically transparent substance such as glass and a metal thin film layer depends on the refractive index of a sample located on the outgoing side of the metal. Accordingly, the sample can be analyzed by measuring the intensity of reflected monochromatic light. The surface plasmon resonance measurement device used in the present invention will be described below.

The surface plasmon resonance measurement device is a device for analyzing the properties of a substance to be measured using a phenomenon whereby a surface plasmon is excited with a lightwave. The surface plasmon resonance measurement device used in the present invention comprises a dielectric block, a metal film formed on a face of the dielectric block, a light source for generating a light beam, an optical system for allowing the above light beam to enter the above dielectric block such that total reflection conditions can be obtained at the interface between the above dielectric block and the above metal film and that components at various incident angles can be contained, and a light-detecting means for detecting the state of surface plasmon resonance by measuring the intensity of the light beam totally reflected at the above interface.

Moreover, as stated above, the above dielectric block is formed as one block comprising the entity of the entrance face and exit face of the above light beam and a face on which the above metal film is formed, and the above metal film is integrated with this dielectric block.

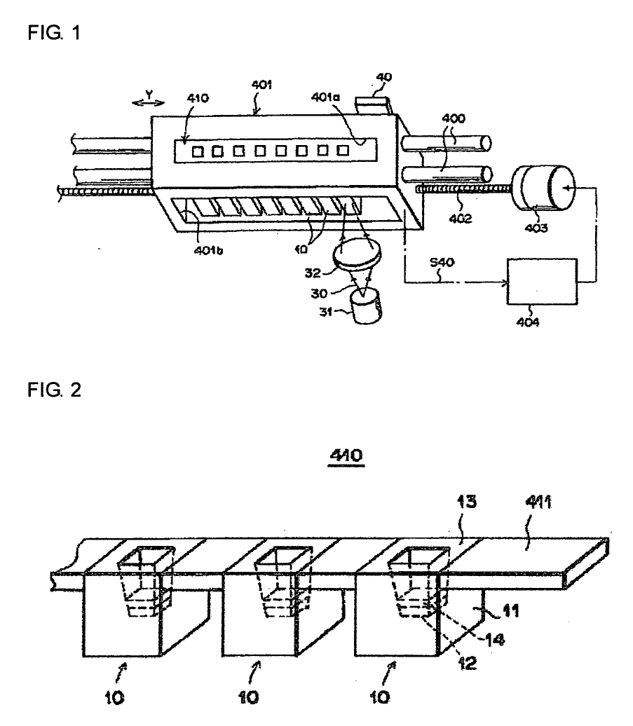

In the present invention, more specifically, a surface plasmon resonance measurement device shown in FIGS. 1 to 32 of Japanese Patent Laid-Open No. 2001-330560, and a surface plasmon resonance device shown in FIGS. 1 to 15 of Japanese Patent Laid-Open No. 2002-296177, can be preferably used. All of the contents as disclosed in Japanese Patent Laid-Open Nos. 2001-330560 and 2002-296177 cited in the present specification are incorporated herein by reference as a part of the disclosure of this specification.

For example, the surface plasmon resonance measurement device described in Japanese Patent Laid-Open No. 2001-330560 is characterized in that it comprises: a dielectric block; a thin metal film formed on a face of the dielectric block; multiple measurement units comprising a sample-retaining mechanism for retaining a sample on the surface of the thin film; a supporting medium for supporting the multiple measurement units; a light source for generating a light beam; an optical system for allowing the above light beam to enter the dielectric block at various angles so that total reflection conditions can be obtained at the interface between the dielectric block and the metal film; a light-detecting means for measuring the intensity of the light beam totally reflected at the above interface and detecting the state of attenuated total reflection caused by surface plasmon resonance; and a driving means for making the above supporting medium, the above optical system and the above light-detecting means move relative to one another, and successively placing each of the above multiple measurement units in a certain position appropriate to the above optical system and the above light-detecting means, so that the above total reflection conditions and various incident angles can be obtained with respect to each dielectric block of the above multiple measurement units.

It is to be noted that in the above measurement device, the above optical system and light-detecting means are kept in a resting state and the above driving means makes the above supporting medium move.

In such a case, the above supporting medium is desirably a turntable for supporting the above multiple measurement units on a circle centered on a rotation axis, and the above driving means is desirably a means for intermittently rotating this turntable. In this case, a medium for supporting the above multiple measurement units that are linearly arranged in a line may be used as the above supporting medium, and a means that makes such a supporting medium move linearly in an intermittent fashion in the direction in which the above multiple measurement units are arranged may be applied as the above driving means.

Otherwise, on the contrary, it may also be possible that the above supporting medium be retained in a resting state and that the above driving means makes the above optical system and light-detecting means move.

In such a case, the above supporting medium is desirably a medium for supporting the above multiple measurement units on a circle, and the above driving means is desirably a means for intermittently rotating the above optical system and light-detecting means along the multiple measurement units supported by the above supporting medium. In this case, a medium for supporting the above multiple measurement units that are linearly arranged in a line may be used as the above supporting medium, and a means that makes the above optical system and light-detecting means move linearly in an intermittent fashion along the multiple measurement units supported by the above supporting medium may be applied as the above driving means.

Otherwise, when the above driving means has a rolling bearing that supports a rotation axis, the driving means is desirably configured such that after the rotation axis has been rotated to a certain direction and a series of measurements for the above multiple measurement units has been terminated, the above rotation axis is equivalently rotated to the opposite direction, and then it is rotated again to the same above direction for the next series of measurements.

In addition, the above-described measurement device is desirably configured such that the above multiple measurement units are connected in a line with a connecting member so as to constitute a unit connected body and that the above supporting medium supports the unit connected body.

Moreover, in the above-described measurement device, it is desirable to establish a means for automatically feeding a given sample to each sample-retaining mechanism of the multiple measurement units supported by the above supporting medium.

Furthermore, in the above-described measurement device, it is desirable that the dielectric block of the above measurement unit be immobilized to the above supporting medium, that a thin film layer and a sample-retaining mechanism of the measurement unit be unified so as to constitute a measurement chip, and that the measurement chip be formed such that it is exchangeable with respect to the above dielectric block.

When such a measurement chip is applied, it is desirable to establish a cassette for accommodating a multiple number of the measurement chips and a chip-supplying means for successively taking a measurement chip out of the cassette and supplying it in a state in which it is connected to the above dielectric block.

Otherwise, it may also be possible to unify the dielectric block of the measurement unit, the thin film layer and the sample-retaining mechanism, so as to constitute a measurement chip, and it may also be possible for this measurement chip to be formed such that it is exchangeable with respect to the above supporting medium.

When a measurement chip has such a structure, it is desirable to establish a cassette for accommodating a multiple number of measurement chips and a chip-supplying means for successively taking a measurement chip out of the cassette and supplying it in a state in which it is supported by the supporting medium.

The above optical system is desirably configured such that it makes a light beam enter the dielectric block in a state of convergent light or divergent light. Moreover, the above light-detecting means is desirably configured such that it detects the position of a dark line generated due to attenuated total reflection, which exists in the totally reflected light beam.

Furthermore, the above optical system is desirably configured such that it makes a light beam enter the above interface in a defocused state. In this case, the beam diameter of the light beam at the above interface in a direction wherein the above supporting medium moves is desirably ten times or greater the mechanical positioning precision of the above supporting medium.

Still further, the above-described measurement device is desirably configured such that the measurement unit is supported on the upper side of the above supporting medium, such that the above light source is placed so as to project the above light beam from a position above the above supporting medium to downwards, and such that the above optical system comprises a reflecting member for reflecting upwards the above light beam projected to downwards as described above and making it proceed towards the above interface.

Still further, the above-described measurement device is desirably configured such that the above measurement unit is supported on the upper side of the above supporting medium, such that the above optical system is constituted so as to make the above light beam enter the above interface from the downside thereof, and such that the above light-detecting means is placed in a position above the above supporting medium with a light-detecting plane thereof facing downwards, as well as comprising a reflecting member for reflecting upwards the totally reflected light beam at the above interface and making it proceed towards the above light-detecting means.

What is more, the above-described measurement device desirably comprises a temperature-controlling means for maintaining the temperature of the above measurement unit before and/or after being supported by the above supporting medium at a predetermined temperature.

Moreover, the above-described measurement device desirably comprises a means for stirring the sample stored in the sample-retaining mechanism of the measurement unit supported by the above supporting medium before detecting the state of attenuated total reflection as mentioned above.

Furthermore, in the above-described measurement device, it is desirable to establish in at least one of the multiple measurement units supported by the above supporting medium a standard solution-supplying means for supplying a standard solution having optical properties associated with the optical properties of the above sample, as well as a correcting means for correcting data regarding the above attenuated total reflection state of the sample based on the data regarding the above attenuated total reflection state of the above standard solution.

In such a case, if the sample is obtained by dissolving a test substance in a solvent, it is desirable that the above standard solution-supplying means be a means for supplying the above solvent as a standard solution.

Still further, the above measurement device desirably comprises: a mark for indicating individual recognition information; a reading means for reading the above mark from the measurement unit used in measurement; an inputting means for inputting sample information regarding the sample supplied to the measurement unit; a displaying means for displaying measurement results; and a controlling means connected to the above displaying means, inputting means and reading means, which stores the above individual recognition information and sample information of each measurement unit while associating them with each other, as well as making the above displaying means display the measurement results of the sample retained in a certain measurement unit while associating them with the above individual recognition information and sample information of each measurement unit.

When a substance interacting with a physiologically active substance is detected or measured using the above-described measurement device, a state of attenuated total reflection is detected in a sample contained in one of the above measurement units, and thereafter, the above supporting medium, optical system and light-detecting means are moved relative to one another, so that a state of attenuated total reflection is detected in a sample contained in another measurement unit. Thereafter, the above supporting medium, optical system and light-detecting means are again moved relative to one another, so that a state of attenuated total reflection is detected again the sample contained in the above one measurement unit, thereby completing the measurement.

The measurement chip used in the present invention is used for the surface plasmon resonance measurement device having a structure described herein, and comprises a dielectric block and a metal film formed on a face of the dielectric block, in which the dielectric block is formed as one block comprising the entirety of the entrance face and exit face of the light beam and a face on which the above metal film is formed, the above metal film is integrated with the above dielectric block.

A metal constituting the metal film is not particularly limited, as long as surface plasmon resonance is generated. Examples of a preferred metal may include free-electron metals such as gold, silver, copper, aluminum or platinum. Of these, gold is particularly preferable. These metals can be used singly or in combination. Moreover, considering adherability to the above substrate, an interstitial layer consisting of chrome or the like may be provided between the substrate and a metal layer.

The film thickness of a metal film is not limited. When the metal film is used for a surface plasmon resonance biosensor, the thickness is preferably between 0.1 nm and 500 nm, and particularly preferably between 1 nm and 200 nm. If the thickness exceeds 500 nm, the surface plasmon phenomenon of a medium cannot be sufficiently detected. Moreover, when an interstitial layer consisting of chrome or the like is provided, the thickness of the interstitial layer is preferably between 0.1 nm and 10 nm.

Formation of a metal film may be carried out by common methods, and examples of such a method may include sputtering method, evaporation method, ion plating method, electroplating method, and nonelectrolytic plating method.

A metal film is preferably placed on a substrate. The description “placed on a substrate” is used herein to mean a case where a metal film is placed on a substrate such that it directly comes into contact with the substrate, as well as a case where a metal film is placed via another layer without directly coming into contact with the substrate. When a substrate used in the present invention is used for a surface plasmon resonance biosensor, examples of such a substrate may include, generally, optical glasses such as BK7, and synthetic resins. More specifically, materials transparent to laser beams, such as polymethyl methacrylate, polyethylene terephthalate, polycarbonate or a cycloolefin polymer, can be used. For such a substrate, materials that are not anisotropic with regard to polarized light and having excellent workability are preferably used.

Preferably, the metal film has a functional group capable of immobilizing a physiologically active substance on the outermost surface of the substrate. The term “the outermost surface of the substrate” is used to mean “the surface, which is farthest from the substrate”.

Examples of a preferred functional group may include —OH, —SH, —COOH, —NR¹R² (wherein each of R¹ and R² independently represents a hydrogen atom or lower alkyl group), —CHO, —NR³NR¹R² (wherein each of R¹, R²and R³ independently represents a hydrogen atom or lower alkyl group), —NCO, —NCS, an epoxy group, and a vinyl group. The number of carbon atoms contained in the lower alkyl group is not particularly limited herein. However, it is generally about C1 to C10, and preferably C1 to C6.

Examples of the method of introducing such a functional group include a method which involves applying a polymer containing a precursor of such a functional group on a metal surface or metal film, and then generating the functional group from the precursor located on the outermost surface by chemical treatment.

In the measurement chip obtained as mentioned above, a physiologically active substance is covalently bound thereto via the above functional group, so that the physiologically active substance can be immobilized on the metal film.

A physiologically active substance immobilized on the surface for the measurment chip of the present invention is not particularly limited, as long as it interacts with a measurement target. Examples of such a substance may include an immune protein, an enzyme, a microorganism, nucleic acid, a low molecular weight organic compound, a nonimmune protein, an immunoglobulin-binding protein, a sugar-binding protein, a sugar chain recognizing sugar, fatty acid or fatty acid ester, and polypeptide or oligopeptide having a ligand-binding ability.

Examples of an immune protein may include an antibody whose antigen is a measurement target, and a hapten. Examples of such an antibody may include various immunoglobulins such as IgG, IgM, IgA, IgE or IgD. More specifically, when a measurement target is human serum albumin, an anti-human serum albumin antibody can be used as an antibody. When an antigen is an agricultural chemical, pesticide, methicillin-resistant Staphylococcus aureus, antibiotic, narcotic drug, cocaine, heroin, crack or the like, there can be used, for example, an anti-atrazine antibody, anti-kanamycin antibody, anti-metamphetamine antibody, or antibodies against O antigens 26, 86, 55, 111 and 157 among enteropathogenic Escherichia coli.

An enzyme used as a physiologically active substance herein is not particularly limited, as long as it exhibits an activity to a measurement target or substance metabolized from the measurement target. Various enzymes such as oxidoreductase, hydrolase, isomerase, lyase or synthetase can be used. More specifically, when a measurement target is glucose, glucose oxidase is used, and when a measurement target is cholesterol, cholesterol oxidase is used. Moreover, when a measurement target is an agricultural chemical, pesticide, methicillin-resistant Staphylococcus aureus, antibiotic, narcotic drug, cocaine, heroin, crack or the like, enzymes such as acetylcholine esterase, catecholamine esterase, noradrenalin esterase or dopamine esterase, which show a specific reaction with a substance metabolized from the above measurement target, can be used.

A microorganism used as a physiologically active substance herein is not particularly limited, and various microorganisms such as Escherichia coli can be used.

As nucleic acid, those complementarily hybridizing with nucleic acid as a measurement target can be used. Either DNA (including cDNA) or RNA can be used as nucleic acid. The type of DNA is not particularly limited, and any of native DNA, recombinant DNA produced by gene recombination and chemically synthesized DNA may be used.

As a low molecular weight organic compound, any given compound that can be synthesized by a common method of synthesizing an organic compound can be used.

A nonimmune protein used herein is not particularly limited, and examples of such a nonimmune protein may include avidin (streptoavidin), biotin, and a receptor.

Examples of an immunoglobulin-binding protein used herein may include protein A, protein G, and a rheumatoid factor (RF).

As a sugar-binding protein, for example, lectin is used.

Examples of fatty acid or fatty acid ester may include stearic acid, arachidic acid, behenic acid, ethyl stearate, ethyl arachidate, and ethyl behenate.

When a physiologically active substance is a protein such as an antibody or enzyme, or nucleic acid, an amino group, thiol group or the like of the physiologically active substance is covalently bound to a functional group located on a metal surface, so that the physiologically active substance can be immobilized on the metal surface.

A measurement chip to which a physiologically active substance is immobilized as described above can be used to detect and/or measure a substance which interacts with the physiologically active substance.

The present invention is described in detail by the following example, but the scope of the present invention is not limited by the example.

### EXAMPLE

The following experiment was carried out using a device shown in FIG. 22 of Japanese Patent Laid-Open No. 2001-330560 (hereinafter referred to as the surface plasmon resonance measurement device of the present invention) (shown in FIG. 1 of the present specification) and a dielectric block shown in FIG. 23 of Japanese Patent Laid-Open No. 2001-330560 (hereinafter referred to as the dielectric block of the present invention) (shown in FIG. 2 of the present specification).

In the surface plasmon resonance measurement device shown in FIG. 1, a slide block 401 is used as a supporting medium for supporting measurement units, which is joined to two guide rods 400, 400 placed in parallel with each other while flexibly sliding in contact, and which also flexibly moves linearly along the two rods in the direction of an arrow Y in the figure. The slide block 401 is screwed together with a precision screw 402 placed in parallel with the above guide rods 400, 400, and the precision screw 402 is reciprocally rotated by a pulse motor 403 which constitutes a supporting medium-driving means together with the precision screw 402.

It is to be noted that the movement of the pulse motor 403 is controlled by a motor controller 404. This is to say, an output signal S 40 of a linear encoder (not shown in the figure), which is incorporated into the slide block 401 and detects the position of the slide block 401 in the longitudinal direction of the guide rods 400, 400, is inputted into the motor controller 404. The motor controller 404 controls the movement of the pulse motor 403 based on the signal S 40.

Moreover, below the guide rods 400, 400, there are established a laser light source 31 and a condenser 32 such that they sandwich from both sides the slide block 401 moving along the guide rods, and a photodetector 40. The condenser 32 condenses a light beam 30. In addition, the photodetector 40 is placed thereon.

In this embodiment, a stick-form unit connected body 410 obtained by connecting and fixing eight measurement units 10 is used as an example, and the measurement units 10 are mounted on the slide block 401 in a state in which eight units are arranged in a line.

FIG. 2 shows the structure of the unit connected body 410 in detail. As shown in the figure, the unit connected body 410 is obtained by connecting the eight measurement units 10 by a connecting member 411.

This measurement unit 10 is obtained by molding a dielectric block 11 and a sample-retaining frame 13 into one piece, for example, using transparent resin or the like. The measurement unit constitutes a measurement chip that is exchangeable with respect to a turntable. In order to make the measurement chip exchangeable, for example, the measurement unit 10 may be fitted into a through-hole that is formed in the turntable. In the present example, a sensing substance 14 is immobilized on a metal film 12.

(1) Preparation of a Dextran Measuring Chip

After treating a dielectric block of the invention having a 50 nm metal film of gold evaporated thereon with the Model-208 UV-ozone cleaning system (TECHNOVISION INC.) for 30 minutes, 5.0 mM solution of 11-hydroxy-1-undecanethiol in ethanol/water (80/20) was added such that the solution came into contact with the metal film. The surface was then treated at 25° C. for 18 hours. Thereafter, washing was performed 5 times with ethanol, once with an ethanol/water mixture solvent, and 5 times with water.

Then, the surface coated with 11-hydroxy-1-undecanethiol was brought into contact with 10% by weight epichlorohydrin solution (solvent: 1:1 mixture solution of 0.4M sodium hydroxide and diethylene glycol dimethyl ether) and reacted in a shaking incubator at 25° C. for 4 hours. The surface was then washed twice with ethanol and 5 times with water.

4.5 ml of 1M sodium hydroxide was then added to 40.5 ml of 25% by weight aqueous solution of dextran (T500, Pharmacia), and the solution was brought into contact with the epichlorohydrin-treated surface. The block was incubated in the shaking incubator at 25° C. for 20 hours. The surface was then washed 10 times with water of 50° C.

A mixture in which 3.5 g of bromoacetic acid had been dissolved in 27 g of 2M sodium hydroxide solution was brought into contact with the dextran-treated surface. After incubation in the shaking incubator at 28° C. for 16 hours, the surface was washed with water. Thereafter, the above-described procedure was repeated once.

(2) Preparation of an Anti-CA-immobilized chip

After solutions were removed from the above dextran measuring chip, 70 μl of a mixture solution of 200 mM EDC (N-ethyl-N′-(3-dimethylaminopropyl)carbodiimide hydrochloride) and 50 mM NHS (N-hydroxysuccinimide) was added and the chip was then allowed to stand for 10 minutes. After the mixture solution was removed, the chip was washed three times with 100 μl of water and three times with 100 μl of Acetate 4.5 buffer (produced by Biacore). The chip filled with 100 μl of Acetate 4.5 buffer was set on the surface plasmon resonance measurement device of the present invention. The inside of the chip was replaced with anti-Carbonic Anhydrase antibody (hereafter referred to as Anti-CA, which was purchased from COSMO BIO Co., Ltd.(NOR)) solution (dissolved in Acetate 4.5 (produced by BIAcore) to 100 μml), and the chip was allowed to stand for 30 minutes for immobilizing the Anti-CA. The inside of the chip was then replaced with 1M ethanolamine solution, and the chip was allowed to stand for 10 minutes. The inside of the chip was washed ten times with 100 μl of Acetate 4.5 buffer, thereby preparing an Anti-CA-immobilized chip. The amount of change in resonance signal due to Anti-CA immobilization was 15,000RU. After the measurement of the signal change, the inside of the Anti-CA-immobilized chip was washed three times with 100μl of 1×PBS (pH7.4) buffer (Wako Pure Chemical Industries, Ltd.).

(3) Preparation of a Fluid Channel System

The dielectric block of the Anti-CA-immobilized chip was then capped with a silicon rubber, thereby preparing a cell with an inner volume of 15 μl. Also, a fluid channel system was prepared by making two 1-mm φ holes in the silicon rubber cap and putting a teflon tube (registered trademark) with an internal diameter of 0.5 mm and an external diameter of 1 mm through the holes. Individual chips with such fluid channel system were set on the surface plasmon resonance measurement device of the present invention.

(4) Immobilization of CA and Evaluation of Hydrochlorothiazide Binding Capacity

The inside of the fluid channel system was filled with 1×PBS (pH7.4) buffer. Signal changes were measured at 0.5 seconds intervals with reference to the signal prior to the replacement of the fluid. The inside of the fluid channel system was then replaced with Carbonic Anhydrase (produced by SIGMA, hereinafter referred to as CA) solution (dissolved in 1×PBS (pH7.4) to 100 μg/ml). When the binding signal reached 3,000RU, the inside was replaced with Hydrochlorothiazide (produced by SIGMA) solution (dissolved in 1×PBS (pH7.4) to 50 μM) by the individual methods indicated in Table 1. Table 1 shows signal changes two minutes after the start of replacement. In order to obtain highly reliable data, it is preferable that the compound binding detection signal be 5RU or more.

TABLE 1

| | Fluid Replacement Methods | | | | | |
|---|---|---|---|---|---|---|
| | | | Replace- | | | |
| | Amount of | Flow | ment | Stop | Signal | |
| | fluid used | velocity | time | time | change | |
| No. | (μ 1) | (μ 1/sec) | (sec) | (sec) | (RU) | Note |
| 1 | 100 | 100 | 1 | 119 | 15 | Example |
| 2 | 100 | 10 | 10 | 110 | 12 | Example |
| 3 | 150 | 5 | 30 | 90 | 10 | Example |
| 4 | 200 | 20 | 10 | 110 | 10 | Example |
| 5 | 300 | 2.5 | 120 | 0 | −1 | Comparative |
| | | | | | | example |
| 6 | 600 | 5 | 120 | 0 | −4 | Comparative |
| | | | | | | example |
| 7 | 1200 | 10 | 120 | 0 | −10 | Comparative |
| | | | | | | example |
| 8 | 2400 | 20 | 120 | 0 | −20 | Comparative |
| | | | | | | example |

The results shown in Table 1 indicate that, in accordance with the measuring method of the invention, the negative drift of the baseline signal can be reduced and highly reliable measurement results can be obtained.

### EFFECTS OF THE INVENTION

In accordance with the biosensor of the invention, the negative drift of the baseline signal can be reduced when measuring a specific binding reaction between a physiologically active substance and a test substance with the use of a surface plasmon resonance measurement device.

1. A biosensor comprising a substrate on the surface of which a physiologically active substance is immobilized via noncovalent bond, which is used for a method for detecting or measuring a substance that interacts with the physiologically active substance, with the use of a fluid channel system comprising a cell formed on the substrate, in a state where the flow of the liquid has been stopped after the liquid contained in said flow channel system has been exchanged.

2. The biosensor according to claim 1, wherein the substrate is a metal surface or a metal film.

3. The biosensor according to claim 2, wherein the metal surface or the metal film consists of a free electron metal selected from the group consisting of gold, silver, copper, platinum, and aluminum.

4. The biosensor according to claim 1, which is used in non-electrochemical detection.

5. The biosensor according to claim 1, which is used in surface plasmon resonance analysis.

6. The biosensor according to claim 1, wherein the binding constant (K_{A}) of the noncovalent bond is 10⁷ M or more.

7. The biosensor according to claim 1, wherein the noncovalent bond is any one of avidin-biotin binding, antigen-antibody reaction, coordinate bond by metal ligand, and nucleotide-nucleotide interaction.

8. A method for measuring a change in surface plasmon resonance which comprises: using a surface plasmon resonance measurement device comprising a metal film on the surface of which a physiologically active substance is immobilized via noncovalent bond, a flow channel system having a cell formed on the metal film, and a light-detecting means for detecting the state of surface plasmon resonance by measuring the intensity of a light beam totally reflected on the meal film; and exchanging the liquid contained in said flow channel system, wherein the above method is characterized in that a change in surface plasmon resonance is measured in a state where the flow of the liquid has been stopped, after the liquid contained in said flow channel system has been exchanged.
